(19) United States
(12) Patent Application Publication
(10) Pub. No.: US 2015/0360862 A1
(43) Pub. Date: Dec. 17, 2015

(54) Trash Can Anchoring Device

(71) Applicant: Pete Siepierski, South Wales, NY (US)

(72) Inventor: Pete Siepierski, South Wales, NY (US)

(21) Appl. No.: 14/742,386

(22) Filed: Jun. 17, 2015

Related U.S. Application Data
(60) Provisional application No. 62/013,262, filed on Jun. 17, 2014.

(51) Int. Cl. B65F 1/14; B62B 1/26; B65F 1/16

(52) U.S. Cl. CPC B65F 1/141; B65F 1/1468; B65F 1/1473; B65F 1/16; B62B 1/26; B65F 2250/111

(57) ABSTRACT

A trash can anchoring device for holding a trash can therein and preventing the trash can from tipping over. The trash can anchoring device includes a container having a base, one or more sidewalls, and an open upper end, defining an interior volume. The trash can anchoring device further includes a horizontal dividing wall disposed on the interior of the container, wherein a lower and upper compartment are formed. The upper compartment can receive a trash can therein and the lower compartment houses a magnet disposed on the underside of the dividing wall, wherein the magnet can be positioned over a magnetic receiving plate affixed to the ground. The magnetic connection prevents the trash can anchoring device from tipping over. A secondary plate is disposed in the lower compartment and adjustably secured to the container, such that the plate can interrupt the magnetic connection.

### CROSS REFERENCE TO RELATED APPLICATION

This application claims the benefit of U.S. Provisional Application No. 62/013,262 filed on Jun. 17, 2014. The above identified patent application is herein incorporated by reference in its entirety to provide continuity of disclosure.

### BACKGROUND OF THE INVENTION

### Field of the Invention

The present invention relates to trash can anchoring devices. More specifically, the present invention provides a trash can anchoring device comprising a container having an upper compartment and a lower compartment, wherein the upper compartment is adapted to receive a trash can therein. The lower compartment houses a magnet adapted to engage with a magnetic receiving plate disposed on the ground. The lower compartment further comprises a secondary plate adjustably secured to the container, such that the secondary plate, preferably composed of aluminum, is adapted to be positioned between the magnet and the magnetic receiving plate in order to interrupt the magnetic connection so the trash can anchoring device can be moved.

Many individuals place their trash cans outdoors, such as on the end of the driveway for trash removal or near the house in order to prevent odors from entering the home. However, these trash cans are often left unsecured, thereby allowing the trash cans to tip over easily due to windy weather conditions or animals rummaging through the trash looking for food. Furthermore, trash cans that have fallen over often roll into the street, resulting in cars swerving in order to avoid colliding with the trash cans. However, vehicles swerving on the road may result in collisions with other vehicles or objects on the road. Additionally, trash cans that are tipped over spill garbage onto the streets or onto the individual's driveway, which creates a large mess to clean and annoys neighbors due to the resulting eyesore. Therefore, there exists a need in the prior art for a device that anchors and supports a trash can in an upright position, thereby preventing the trash can from tipping over.

It is submitted that the present invention substantially diverges in design elements from the prior art and consequently it is clear that there is a need in the art for an improvement to existing trash can anchoring devices. In this regard the instant invention substantially fulfills these needs.

### SUMMARY OF THE INVENTION

In view of the foregoing disadvantages inherent in the known types of trash can anchoring devices now present in the prior art, the present invention provides a new trash can anchoring device wherein the same can be utilized for providing convenience for the user when maintaining a trash can in an upright position and preventing the trash can from tipping over.

It is therefore an object of the present invention to provide a new and improved trash can anchoring device that has all of the advantages of the prior art and none of the disadvantages.

It is another object of the present invention to provide a trash can anchoring device comprising a container having a base, one or more sidewalls, and an open upper end, defining an interior volume therein.

Another object of the present invention is to provide a trash can anchoring device comprising a horizontal dividing wall disposed in the container, such that a lower and upper compartment are created, wherein the upper compartment is adapted to receive a trash can therein.

Yet another object of the present invention is to provide a trash can anchoring device wherein the lower compartment houses a magnet adapted to engage with a magnetic receiving plate disposed on the ground beneath the container so as to anchor the trash can to the ground and prevent the trash can from tipping or falling over.

Yet another object of the present invention is to provide a trash can anchoring device further comprising a secondary plate that is adjustably secured to the container within the lower compartment, wherein the secondary plate is adapted to be positioned between the magnet and the magnetic receiving plate in order to interrupt the magnetic connection so the trash can is able to be moved.

Another object of the present invention is to provide a trash can anchoring device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the trash can anchoring device.

FIG. 2 shows a cross sectional view of an embodiment of the trash can anchoring device.

FIG. 3 shows a bottom plan view of the lower compartment of the trash can anchoring device.

FIG. 4 shows a cross sectional view of an embodiment of the trash can device wherein the secondary plate is positioned beneath the magnet.

### DETAILED DESCRIPTION OF THE INVENTION

Reference is made herein to the attached drawings. Like reference numerals are used throughout the drawings to depict like or similar elements of the trash can anchoring device. For the purposes of presenting a brief and clear description of the present invention, the preferred embodiment will be discussed as used for supporting a trash can in an upright position and preventing the trash can from tipping over. The figures are intended for representative purposes only and should not be considered to be limiting in any respect.

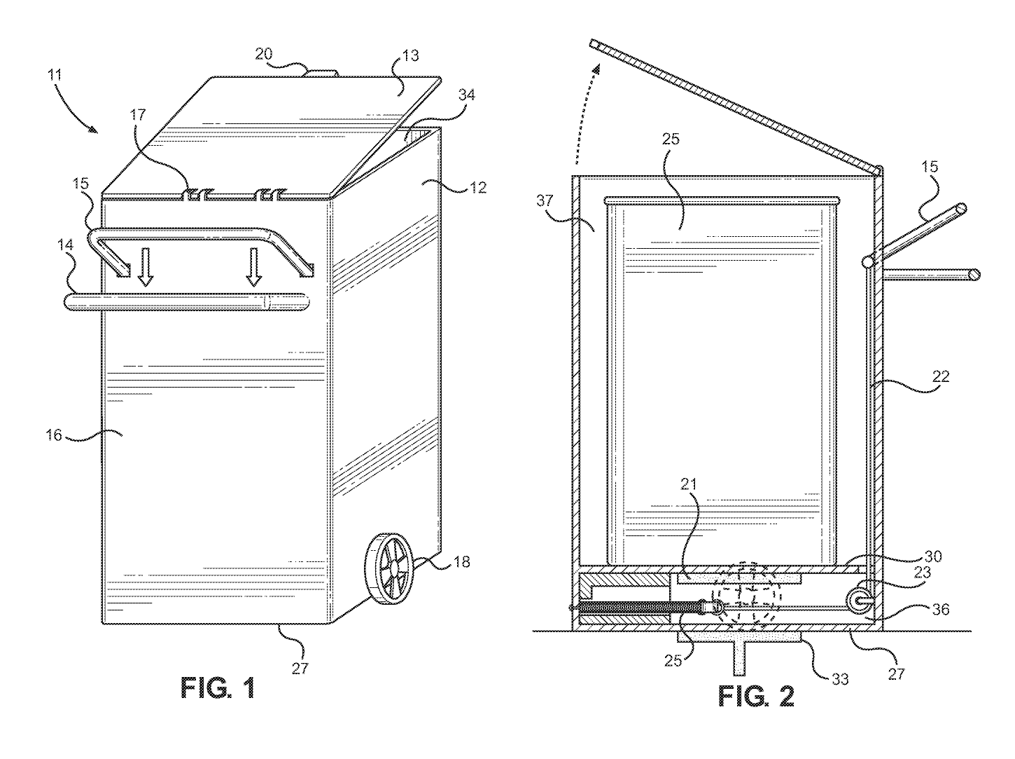

Referring now to FIG. 1, there is shown a perspective view of an embodiment of the trash can anchoring device. The trash can anchoring device 11 comprises a container 12 having a base 27, one or more sidewalls 16, and an open upper end 34, defining an interior volume therein. The interior volume of the container 12 is adapted to hold trash or a trash can therein. In the illustrated embodiment, the container 12 is rectangular in shape. However, in other embodiments, the container 12 can be any suitable shape, such as a cylinder, in order to correspond to the shape of a trash can inserted therein.

The container 12 comprises a pair of wheels 18 disposed on the lower end of opposing sidewalls 16 of the container 12 so as to allow the container 12 to roll along a surface. The exterior of the container 12 further comprises a movable elongated handlebar 15 and a fixed elongated handlebar 14. The fixed elongated handlebar 14 is horizontally oriented and adapted to provide an area for a user to grip in order to move the trash can anchoring device 11. The movable handlebar 15 is operably connected to a pulley system disposed on the interior of the container 12, wherein the movable handlebar 15 is adapted to be depressed in order to activate the pulley system that is used to interrupt a magnetic connection that anchors the trash can anchoring device 11 to the ground. In the illustrated embodiment, the handlebars 14, 15 are disposed on the same sidewall 16. In other embodiments, the movable handlebar 14 can comprise any suitable configuration, such as lever disposed on the upper end of a sidewall 16. In some embodiments, the movable handlebar 15 is replaced by a foot pedal disposed on the lower end of a sidewall 16. The foot pedal operates in the same manner as the movable handlebar 15, wherein the foot pedal is operably connected to the pulley system.

The open upper end 34 of the container 12 is removably covered by a lid 13 that is pivotally attached thereto by one or more hinges 17 disposed on the upper end of a sidewall 16 of the container 12. The lid 13 is adapted to seal the trash can anchoring device 11 in order to keep animals from accessing the interior of the container 12 and to prohibit foul smells from leaving the container 12. The lid 13 comprises a tab 20 extending from an edge thereof in order to allow a user to grasp and lift the lid 13. In some embodiments, the trash can anchoring device 11 is maintained in a closed position via a locking mechanism, such as a latch.

Referring now to FIG. 2, a cross sectional view of an embodiment of the trash can anchoring device. The trash can anchoring device 11 further comprises a dividing wall 30 horizontally disposed on the interior of the container 12. The dividing wall 30 comprises a planar surface, wherein the perimeter of the dividing wall 30 is affixed to the interior perimeter of the container 12. The dividing wall 30 is permanently affixed to the sidewalls 16 of the container 12 by any suitable fastener, such as adhesive, or the dividing wall 30 and container 12 are integral to one another. In this way, the dividing wall 30 creates an upper compartment 37 and a lower compartment 36, wherein the upper compartment 37 is adapted to receive trash or a trash can 25 therein.

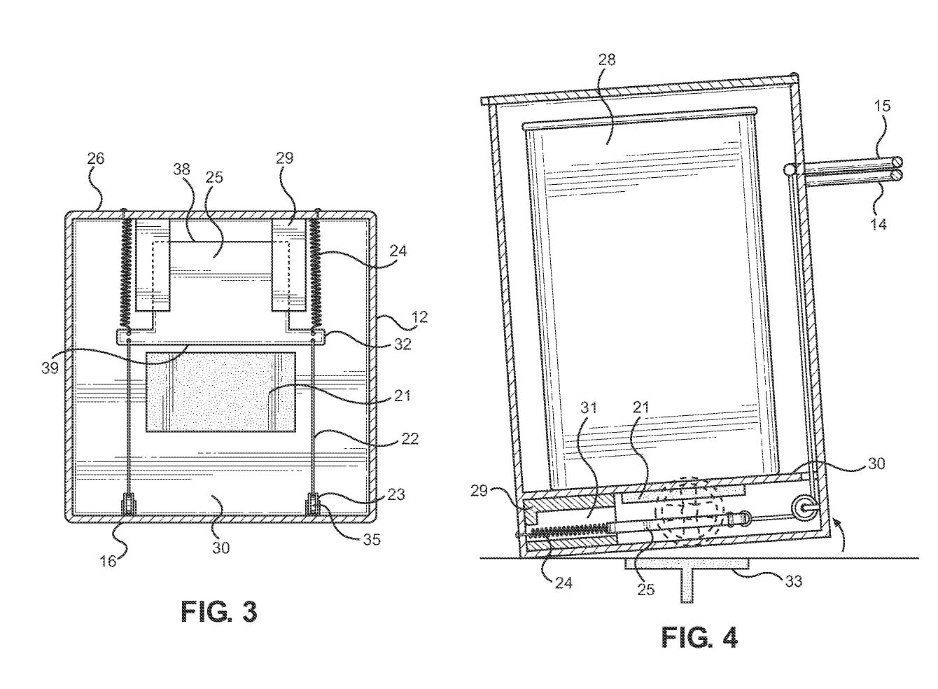

The lower compartment 36 houses operating components adapted to prevent the trash can anchoring device 11 from tipping over. The operating components comprise the pulley system having one or more cables 22 and one or more pulley wheels 23, wherein the pulley wheels 23 are rotatably secured to a sidewall 16 in the lower compartment 36 of the container 12. The pulley wheels 23 are rotatably secured to the same sidewall 16 comprising the movable handlebar 15. The pulley wheel 23 engages a cable 22 so as to reduce surface friction and allow the cable 22 to move therealong. Each pulley wheel 23 comprises a groove (as referenced in FIG. 3, 35) disposed along the circumference thereof, wherein the groove is adapted to receive a cable 22 therein.

The illustrated embodiment comprises a pair of pulley wheels 23 and a pair of cables 22, wherein the cables 22 are parallel to one another. The first cable 22 aligns with a first pulley wheel 23 and the second cable 22 aligns with a second pulley wheel 23. Each cable 22 comprises a first end and a second end, wherein the first end of a cable 22 is secured to the movable handlebar. Each cable 22 extends downward from the movable handlebar 15 within the interior of the container 12 and engages the groove of a pulley wheel 23 so as to be positioned between the pulley wheel 23 and the sidewall 16 of the container 12. At the point of engagement with the pulley wheel 23, the cables 22 comprise a ninety degree angle so as to be parallel to the base 27 of the container 12 and disposed within the lower compartment 36. The cables 22 extend horizontally from the pulley wheels 23, wherein the second end of each cable 22 is secured to a secondary plate 25 disposed within the lower compartment 36. When the movable handlebar 15 is depressed, the secondary plate 25 is adapted to move towards the pulley wheel 23. As the secondary plate 25 moves towards the pulley wheel 23, the secondary plate 25 becomes positioned between a magnet 21 and a magnetic receiving plate 33, thereby interrupting a magnetic connection that anchors the trash can anchoring device to the ground

Referring now to FIG. 3, there is shown a bottom up view of lower compartment of the trash can anchoring device. The secondary plate 25 comprises a planar surface having a first end 38 and a second end 39. The first end 38 of the secondary plate 25 is disposed on a slotted track 29 that is adapted to guide the secondary plate 25 therealong when the pulley system is engaged. The slotted track 29 comprises a first part and a second part secured to a sidewall 16 of the container. The slotted track 29 is preferably disposed on a sidewall 26 opposing the sidewall 16 comprising the pulley wheels 23 thereon so as to allow the cables 22 to pull the secondary plate 25 theretowards. Each of the first and second parts comprise a horizontal slot therein (as referenced in FIG. 4, 31), wherein each slot is adapted to receive a lateral side of the secondary plate 25 therein. The slotted track 29 is secured to the sidewall 26 within the lower compartment by any suitable fastener, such as adhesive or it is integral thereto. In other embodiments, the slotted track 29 can be disposed on any suitable surface within the lower compartment, such as the base or the underside of the dividing wall 30.

In the illustrated embodiment, the secondary plate 25 is rectangular in shape, with the exception of a first tab 32 and a second tab 32 extending perpendicularly from the second end 39 thereof. The tabs 32 of the secondary plate 25 extend beyond the slotted track 29 so as to allow the tabs 32 to connect to a pair of springs 24 disposed on the outer side of the slotted track 29. The first cable 22 is secured to the first tab 32 and the second cable 22 is secure to the second tab 32. The tabs 32 are further secured to a pair of springs 24, wherein the opposing ends of each spring 24 are secured to a sidewall 26 of the container 12. The opposing ends of each spring 24 are preferably disposed on a sidewall 26 opposite the sidewall 16 comprising the pulley wheels 23.

The springs 24 are adapted to provide tension on the secondary plate 25 and the pulley system, such that when the movable handlebar 15 is depressed, the spring 24 becomes tensioned so as to exert a biasing force tending to return the secondary plate 25 to its unbiased position within the slotted track 29. In other embodiments, one or more springs 24 can be disposed in any suitable configuration. For example, in an alternative embodiment, the springs 24 are disposed between the first and second parts of the slotted track 29, wherein a first end of the springs 24 is secured to the first end 38 of the secondary plate 25, instead of the tabs 32, and a second end of the springs 24 is secured to the sidewall 29. In this way, the springs 24 perform the same function as in the illustrated embodiment, but are oriented differently.

The lower compartment further comprises one or more magnets 21 disposed on the dividing wall 30. In the illustrated embodiment, a rectangular shaped magnet 21 is disposed on the underside of the dividing wall 30. However, in other embodiments, the magnet 21 can be any suitable shape, such as a circle. The magnet 21 is secured to the dividing wall 30 by any suitable fastener, such as by means of adhesives. The magnet 21 is adapted to be positioned over a magnetic receiving plate disposed on a support surface beneath the container 12, wherein the magnetic receiving plate is preferably composed of a ferromagnetic material, such that the magnet 21 and the magnetic receiving plate are magnetically attracted to one another. In this way, the magnetic attraction anchors the trash can anchoring device to the ground and prevents the device from becoming tipped over by such elements as the wind. A user can incorporate a magnetic receiving plate on the surface of the end of a driveway or other outdoor area in which a trash can is typically positioned. In other embodiments, the magnetic receiving plate can be disposed on the underside of the dividing wall 30 and adapted to attract a magnet 21 disposed on the surface beneath the container 12.

Referring now to FIG. 4, there is shown a cross sectional view of an embodiment of the trash can device wherein the secondary plate is positioned beneath the magnet. The secondary plate 22 is composed of any suitable material that is adapted to interrupt a magnetic connection, such as aluminum. In the resting state, the secondary plate 25 is disposed in the slotted track 29 and not aligned under the magnet 21. In operation, a trash can 28 is disposed within the interior of the container 12, wherein it rests on the dividing wall 30, and positioned over the magnetic receiving plate 33 disposed on the ground. In order to then move the trash can anchoring device, the movable handlebar 15 is depressed, thereby pulling the cable 22 upwards and resulting in the secondary plate 25 becoming positioned between the magnet 21 and the magnetic receiving plate 33. As the movable handlebar 15 is depressed, the fixed handlebar 14 can be used to lift or roll the container away from the magnetic receiving plate 33.

In some embodiments, the trash can anchoring device 11 comprises an electromagnet that can be electronically demagnetized in order to transport the trash can 28 from one place to another. The electromagnet is operably connected to a control button disposed on the container 12 that when pressed, the electromagnet becomes demagnetized. Therefore, the electromagnet provides an alternative anchoring mechanism that interrupts the magnetic connection between the electromagnet and the magnetic receiving plate 33.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A trash can anchoring device, comprising:
a container comprising a base, one or more sidewalls, and an open upper end, defining an interior volume, wherein said interior volume is adapted to receive a trash can therein;
a horizontal dividing wall disposed in said interior volume, so as to form an upper compartment and a lower compartment within said container;
one or more magnets disposed on said horizontal dividing wall and adapted to attract a magnetic receiving plate disposed therebeneath on a ground;
said magnetic receiving plate, wherein said magnetic receiving plate is separate from said container and adapted to be positioned on said ground beneath said one or more magnets;
a secondary plate adjustably secured and operably connected to said lower compartment of said container, such that said secondary plate is adapted to interrupt a magnetic attraction between said one or more magnets and said magnetic receiving plate.

2. The trash can anchoring device of claim 1, further comprising a movable handlebar disposed on an exterior of said one or more sidewalls of said container and operably connected to a pulley system disposed on said interior of said container, wherein said pulley system is operably secured to said secondary plate, such that when said movable handlebar is depressed, said secondary plate is positioned beneath said one or more magnets.

3. The trash can anchoring device of claim 2, wherein said pulley system comprises one or more cables secured to said movable handlebar and said secondary plate, and one or more pulley wheels disposed in said lower compartment and secured to said one or more sidewalls of said container, such that said one or more cables engage said one or more pulley wheels.

4. The trash can anchoring device of claim 2, further comprising one or more springs having a first end and a second end, wherein a first end is secured to said secondary plate and said second end is secured to one or more sidewalls of said container, such that said one or more springs exerts a biasing force adapted to return said secondary plate to a resting position.

5. The trash can anchoring device of claim 1, further comprising a lid adjustably secured to said open upper end of said container.

6. The trash can anchoring device of claim 1, further comprises a slotted track disposed in said lower compartment of said container, wherein said secondary plate is movable along said slotted track.

7. The trash can anchoring device of claim 1, wherein said secondary plate is composed of aluminum.

8. The trash can anchoring device of claim 1, further comprising a pair of wheels disposed on a lower end of said one or more sidewalls of said container and adapted to roll said container on a surface.

9. The trash can anchoring device of claim 1, further comprising a fixed handlebar secured to said one or more sidewalls of said container.
